(19) United States
(12) Patent Application Publication
(10) Pub. No.: US 2006/0197244 A1
(43) Pub. Date: Sep. 7, 2006

(54) Mold fixture to densify composite beam key using resin transfer molding

(75) Inventors: Allen H. Simpson, Buchanan, MI (US); Mark L. La Forest, Granger, IN (US); Slawomir T. Fryska, Granger, IN (US); Roger L. Klinedinst, North Liberty, IN (US); Robert E. De Ferbrache, Elkhart, IN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/073,907

(22) Filed: Mar. 7, 2005

(51) Int. Cl. C01B 31/00

(52) U.S. Cl. 264/29.7; 264/328.4; 264/101; 425/129.1

(57) ABSTRACT

A resin transfer molding (RTM) apparatus (10) that includes: an extruder (4); at least two mold cavities (15) contained within a mold (16, 18) in the apparatus, arranged so that resin can be extruded from the extruder (4) into the mold; a nozzle (20) for delivering resin from the extruder (4) into the mold; runners (25) in the body of the mold to deliver resin from the nozzle (20) to a mold cavity (15) within the mold; a venting area (29) contiguous to each mold cavity to permit gases to escape from the mold cavity (15) when the mold cavity is infiltrated with resin; and a press (12) to force the mold (16, 18) closed during at least resin injection. An advantageous feature of the present invention is that the mold may be configured to accept a part (19) that is characterized by variations in length, width, and/or thickness, such as a wheel beam key. Also, an RTM process. The process includes: placing a porous preform, e.g., a wheel beam key preform, that is characterized by variations in length, width, and/or thickness into a mold held in a press; injecting a molten resin or pitch into the mold, wherein an extruder is used for injecting the resin; allowing the resin to cool below the melting point; and removing the impregnated preform from the mold. This process is especially adapted for processing fibrous preforms, carbon fiber preforms, nonwoven preforms, random fiber preforms with binder, and foam preforms.

### FIELD OF THE INVENTION

The present invention provides an apparatus and method for filling a fibrous preform with high viscosity resin or molten pitch. In another, more specific aspect, this invention relates to the densification of a carbon-carbon composite beam key by means of Resin Transfer Molding (RTM). This invention enables the production of C—C composite wheel beam keys that are characterized by high bulk density.

### BACKGROUND OF THE INVENTION

RTM is a fairly common process used for the production of polymer-based composites. A fibrous preform or mat is placed into a mold cavity matching the desired part geometry. Typically, a relatively low viscosity thermoset resin is injected into the mold cavity at room temperature using pressure, or the resin is induced into the mold and preform under vacuum. The resin reacts within the mold, and the cured component is removed from the mold.

RTM was originally developed in the 1940s, but it met with little commercial success until the 1960s and 1970s, when it was used to produce commodity goods like bathtubs, computer keyboards, and fertilizer hoppers. In recent years, resin transfer molding, or RTM, and its derivative processes (which are also called resin injection molding) have been gaining popularity in the aerospace, automotive, and military industries.

Some patents that relate to RTM or similar processes include: U.S. Pat. No. 4,311,661, “Resin Impregnation Process”, McDonnell Douglas Corporation; U.S. Pat. No. 5,232,650, “Fabrication of Detail Parts for Superconducting Magnets by Resin Transfer Molding”, Grumman Aerospace Corporation; U.S. Pat. No. 5,306,448, “Method for Resin Transfer Molding”, United Technologies Corporation; U.S. Pat. No. 6,517,769 B2, “Method And Apparatus for Producing a Structural Unit Made of Fiber Reinforced Material”, Eurocopter Deutschland GmbH; and U.S. Pat. No. 6,537,470 B1, “Rapid Densification of Porous Bodies (Preforms) with High Viscosity Resins or Pitches Using a Resin Transfer Molding Process”, Honeywell International Inc.

U.S. Pat. No. 6,537,470 B1 discloses, in part, the rapid, discrete infiltration of and densification of a porous fibrous preform using high viscosity, high char-yield resin, e.g. mesophase pitch. The '470 patent describes the use of an extruder to uniformly melt and mix the injection media. The '470 patent provides a mold which efficiently and thoroughly distributes the resin into the preform. The resin transfer mold of the '470 patent may have: a top half; a bottom half opposed to the top half so that the top half and the bottom half form a mold cavity; at least one gate disposed in the top half or the bottom half; a valve, wherein the valve can admit resin into the gate; and an arrangement for providing venting and/or vacuum to the mold. A gate, having a nozzle, can be disposed in the center of a face of a mold half. The mold can further be subdivided to form separate cavities for individual preforms. The mold can also have tapered cavities to promote adequate molten resin flow.

The '470 patent also describes a resin transfer molding process that comprises: placing a porous preform into a mold; injecting a molten resin or pitch into the mold; allowing the resin to cool below the melting point; and removing the impregnated preform from the mold. The preform of the '470 patent can be a fibrous preform, a carbon or ceramic fiber preform, a nonwoven preform, a rigidized fibrous preform, a porous carbon or ceramic body, or a (rigidized) foam preform. The preform can be carbonized or graphitized. The preform can be infiltrated using CVI/CVD processes. The preform can be previously resin-infiltrated. The resin or pitch can be a derivative of coal tar, petroleum or synthetic pitch precursors such as synthetic pitch, coal tar pitch, petroleum pitch, mesophase pitch, high char yield thermoset resin, or combinations thereof. In accordance with the process of the '470 patent, multiple parts can be loaded in a single mold.

The '470 patent teaches further that the densified part, following densification, can be treated at elevated temperature in an oxygen-containing environment to effectively cross-link the thermoplastic resin. This process fixes the matrix in place within the preform and prevents softening, bloating, and expulsion of the matrix during subsequent heating above the resin melting temperature. Additional treatments of the densified part in accordance with the method of the '470 patent can include carbonization, graphitization, and reimpregnation using RTM and/or CVI/CVD processes.

### SUMMARY OF THE INVENTION

Previously known Resin Transfer Molding tooling and processes such as that described in U.S. Pat. No. 6,537,470 B1 were designed for the manufacture of annular brake discs. The present invention is concerned with parts that are not uniform in shape. Applicants have discovered a relatively simple mold configuration and processing techniques that enable the infiltration of parts with complicated shapes to high densities. In the context of this invention, a “complicated” part is a part that is characterized by variations in length, width, and/or thickness. This is in contrast to, for instance, an annular brake disc, which has a uniform thickness and width and in which the “length” is not a factor.

The present invention permits RTM infiltration of porous parts having geometric dimensions that are not round in shape. The present invention avoids the necessity of venting around the entire annular circumference of a preform. Annular parts are often filled from their inside diameters to their outside diameters. In the present invention, the resin can flow over and around the part in the mold.

The resin transfer molding apparatus of the present invention will generally include a mold insert cavity which can form separate chambers so that a separate part can fit in each of the separate chambers. Thus, for example, the present invention contemplates molding two or more composite wheel beam keys in a single molding operation.

While the principles of the present invention are illustrated primarily with reference to the molding of carbon-carbon composite wheel beam keys, other sorts of composite wheel beam keys could equally well be infiltrated in the mold apparatus of the present invention. Indeed, the mold apparatus of the present invention could also be configured to enable the infiltration of other composite parts, such as wheel beam key feet, and even of multiple annular brake discs.

### BRIEF DESCRIPTION OF THE DRAWINGS

The present invention will become more fully understood from the detailed description given hereinbelow and the accompanying drawings which are given by way of illustration only, and thus are not limiting of the present invention. The drawings are not drawn to scale.

FIG. 1 shows an inside top plan view of an upper mold insert in accordance with the present invention.

FIG. 2 shows an inside top plan view of a lower mold insert in accordance with the present invention.

FIGS. 3A and 3B illustrate runners and vent ports in an inside top plan view of an upper mold insert in accordance with the present invention

FIG. 4A is a cross-section along line A-A in of mating mold inserts shown in FIG. 3A. FIG. 4B is an enlarged side view of an end portion mating mold inserts shown in FIG. 4A.

FIG. 5 is a schematic cross-section of an extrusion resin molding apparatus according to an embodiment of the present invention.

### DETAILED DESCRIPTION OF THE INVENTION

In one embodiment, the present invention provides a resin transfer molding (RTM) apparatus that includes: an extruder; at least two mold cavities contained within a mold in the apparatus, arranged so that resin can be extruded from the extruder into the mold; a nozzle for delivering resin from the extruder into the mold; runners in the body of the mold to deliver resin from the nozzle to a mold cavity within the mold; a venting area contiguous to each mold cavity to permit gases to escape from the mold cavity when the mold cavity is infiltrated with resin; and a press to force the mold closed during at least resin injection. An advantageous feature of the present invention is that the mold may be configured to accept a part that is characterized by variations in length, width, and/or thickness, such as a wheel beam key. For instance, the mold may be configured to accept wheel beam key preforms having the dimensions 1″ to 5″″ in width, 1″ to 3″ in thickness, and 12″ to 20″ in length.

The resin transfer molding apparatus of this invention can include a piston accumulator disposed between the extruder and the mold. The extruder may be, e.g., a single screw extruder, a twin screw extruder, a vented twin screw extruder, a reciprocating screw extruder, or a twin rotor continuous mixer. In an RTM process of this invention, the resin or molten pitch may be extruded into the mold using the accumulator to hold a constant set pressure on the melt while it is infiltrating a porous beam key. Alternatively, the molten pitch may be extruded into the piston accumulator and injected into the mold cavity to infiltrate the part (e.g., beam key) under a controlled set pressure. The terminology “controlled set pressure” in this context refers to a pressure that is derived to completely infiltrate the porous part without damage. Details on these aspects of processing may be found in U.S. Pat. No. 6,537,470 B1, the disclosure of which is incorporated by reference herein.

The mold in the resin transfer molding apparatus of this invention may include: a top half; a bottom half opposed to the top half so that the top half and the bottom half form a wheel beam key mold cavity—prefer ably at least two separate wheel beam key mold cavities—in the shape of a wheel beam key; at least one gate disposed in the top half or the bottom half or both; a valve, wherein the valve can admit resin into the gate in the top half or the bottom half; and an arrangement to at least one of vent or vacuum the mold. In a preferred embodiment, the mold will include at least two separate runners to conduct resin from the gate separately to the two separate mold cavities and will include two arrangements to separately vent and/or vacuum the two separate mold cavities. Thus this invention contemplates processing in which multiple parts are loaded in a single mold.

In accordance with this invention, the gate may include a nozzle disposed in the center of a face of either the top half or the bottom half of the mold. The mold can also include a vent ring fitted with at least one vent port or vacuum port, or both, an external vent port which is channeled to the vent ports fitted on the vent ring. In a variation, the separate runners may have conventional shutoff means, to enable utilization of the mold when less than all of the separate mold cavities are to be utilized.

In a process embodiment, the present invention contemplates a resin transfer molding process. The process includes the steps of: placing a porous preform, e.g., a wheel beam key preform, that is characterized by variations in length, width, and/or thickness into a mold held in a press; injecting a molten resin or pitch into the mold, wherein an extruder is used for injecting the resin; allowing the resin to cool below the melting point; and removing the impregnated preform from the mold.

The resin transfer molding process of this invention is especially adapted for processing fibrous preforms, carbon fiber preforms, nonwoven preforms, random fiber preforms with binder, and foam preforms. The preforms treated by the process of the present invention may optionally be preforms that have been previously resin-infiltrated and carbonized. The overall process of this invention contemplates carbonized or graphitized preforms, and the infiltration of preforms using chemical vapor deposition (CVD) techniques.

In the resin transfer molding process of this invention, the resin or pitch may be, for example, synthetic pitch, coal tar pitch, petroleum pitch, mesophase pitch, high char yield thermoset resin or combinations thereof.

In accordance with the present invention, the preform may be heated, e.g., to a temperature between about 290-425° C., prior to or after being placed in the mold, and the mold itself may be heated, e.g., to a temperature between about 138-310° C. Vacuum may be provided to the mold prior to injecting the molten resin. Vacuum and/or venting may be provided to the mold during resin injection.

The resin transfer molding process of this invention also contemplates oxygen-stabilizing the impregnated preform by heating the impregnated preform in the presence of an oxygen-containing gas, e.g., at a temperature of about 150-300° C., and optionally carbonizing the oxygen-stabilized impregnated preform, e.g., at a temperature above about 650° C., and optionally graphitizing the carbonized impregnated preform, e.g., at a temperature of about 1400-2500° C. The graphitized preform may be further densified using CVI, CVD, and/or RTM processes that are in general well known to those skilled in the art.

Copending U.S. patent application {H0005904/6494}, entitled “COMPOSITE BEAM KEY”, filed on even date herewith, describes composite wheel beam keys that can be made in accordance with the present invention. The entire disclosure of that application is incorporated herein by reference.

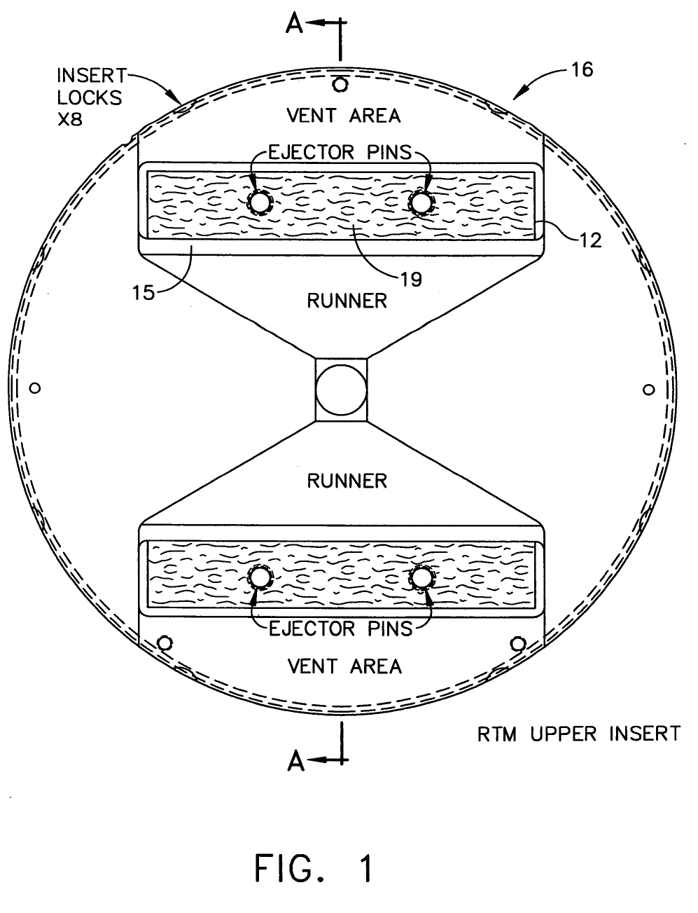

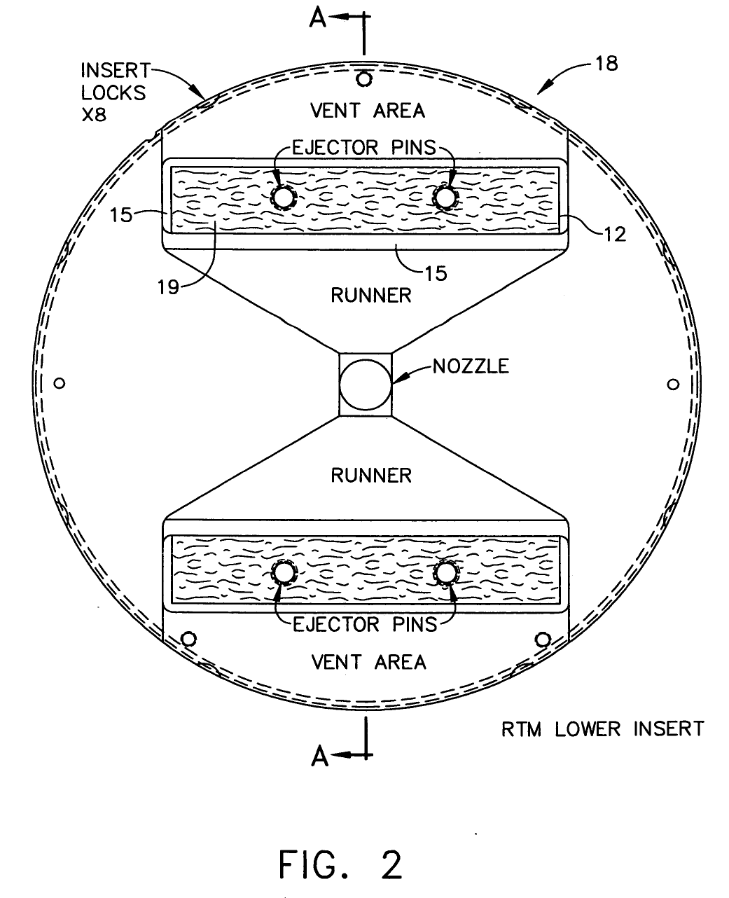

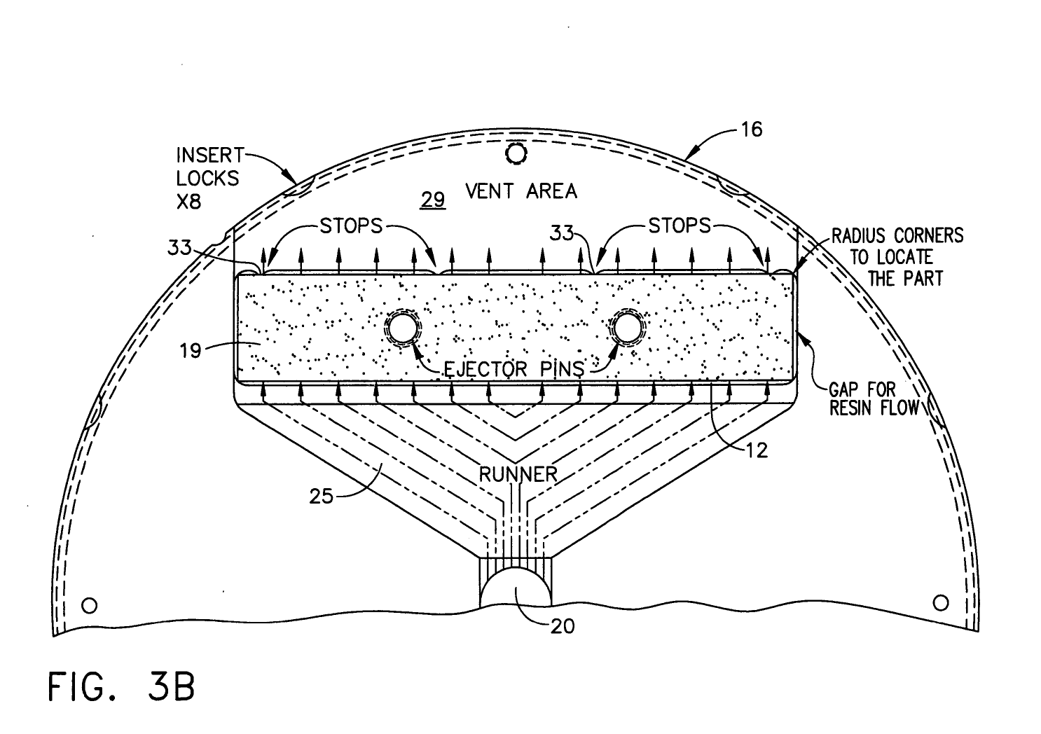

FIG. 1 shows an inside top plan view of an upper mold insert 16 in accordance with the present invention. In this case, the overall outside shape of the mold is circular, so that it can conveniently be utilized in a molding apparatus such as one configured to mold brake discs. However, in accordance with this invention, the mold cavity 15 is rectangular in order to permit RTM treatment of a generally rectangular body such as a carbon-carbon composite wheel beam key. In FIG. 1, two mold cavities 15 are shown partially filled, respectively, by two carbon-carbon composite wheel beam keys 19. A gap 12 surrounds each wheel beam key preform 19. The wheel beam key preform is held in place within the mold cavity 15 but away from the walls by small projections (not shown) extending from the walls. This leaves a gap, which may be e.g. 0.100 inch in width, that permits infiltration of resin into the mold cavity and subsequently into the wheel beam key during RTM processing. Gap 12 also permits gases to escape from the wheel beam key as the gases are pushed out by the resin infiltrating the key. FIG. 1 identifies runner areas and vent areas (shown in more detail in FIG. 3). FIG. 1 also shows the locations of ejector pins that facilitate removal of the resin-impregnated preforms from the mold, and the positions of insert locks that hold the mold insert in the molding apparatus.

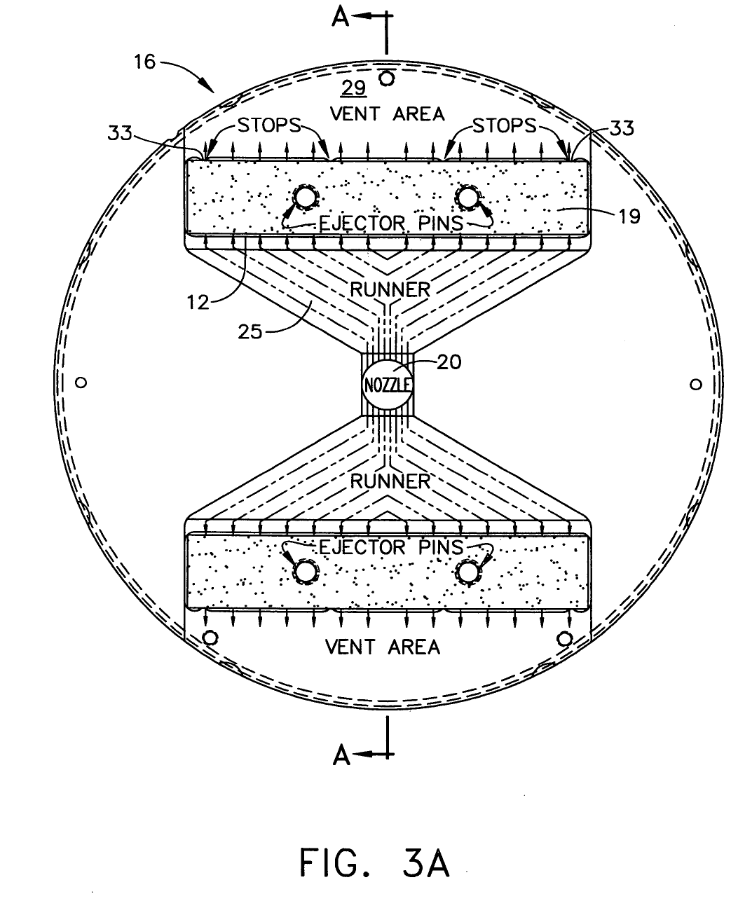

FIG. 2 shows an inside top plan view of a lower mold insert 18 in accordance with the present invention. The mold insert of FIG. 2 is designed to mate with that of FIG. 1. In FIG. 2, two mold cavities 15 are shown partially filled, respectively, by two carbon-carbon composite wheel beam keys 19. A gap 12 surrounds each wheel beam key 19. This gap, which may be e.g. 0.1 inch wide, permits the infiltration of resin into the mold cavity and subsequently into the wheel beam key during RTM processing, and also permits gases to escape from the wheel beam key as the gases are pushed out by the resin infiltrating the key. FIG. 2 identifies runner areas and vent areas. FIG. 2 also shows the locations of ejector pins that facilitate removal of the resin-impregnated preforms from the mold, and the positions of insert locks that hold the mold insert in the molding apparatus.

FIGS. 3A and 3B show an inside top plan view of a lower mold insert 16 in accordance with the present invention. FIG. 3B is an enlarged view of the top portion of FIG. 3A. In FIG. 3A, two mold cavities are shown partially filled, respectively, by two carbon-carbon composite wheel beam key preforms 19. FIG. 3A shows a nozzle 20 that cooperates with fan-shaped ramps (or gates) 25 to deliver molten resin or the like to a wheel key preform 19. As can be seen in FIGS. 3A and 3B, a gap 12 surrounds the portion of each wheel beam key 19 that is not in contact with the runners 25. This gap permits gases to escape from the wheel beam key as the gases are pushed out by the resin infiltrating the key. FIGS. 3A and 3B also shows vent areas 29 through which gases can escape during RTM processing. Finally, FIGS. 3A and 3B show stops 33, which extend from the walls of the mold to hold the wheel beam key preforms in place (that is, to maintain the resin flow gap 12) inside of the mold cavity.

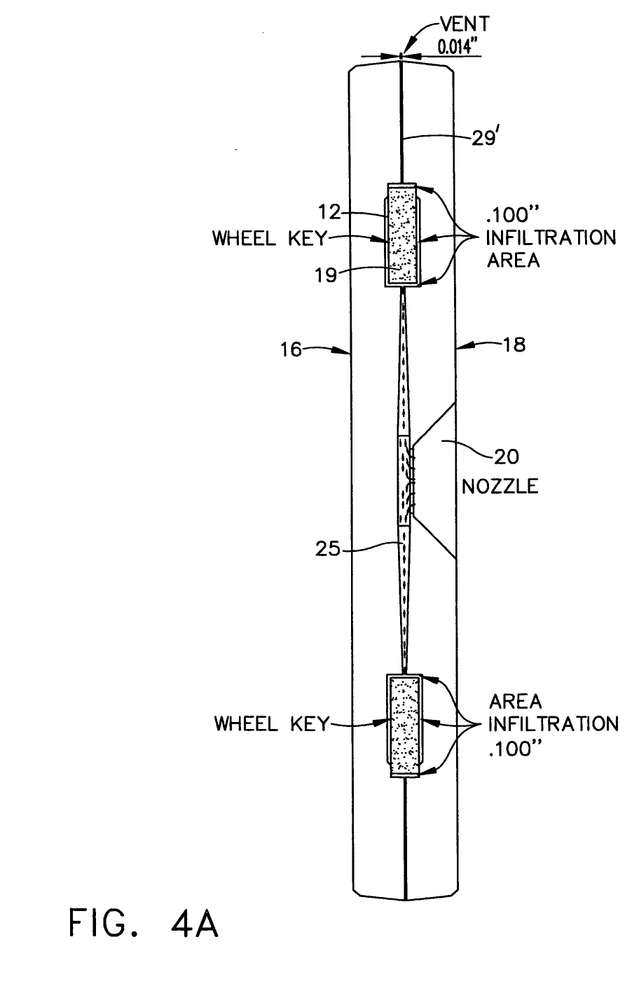

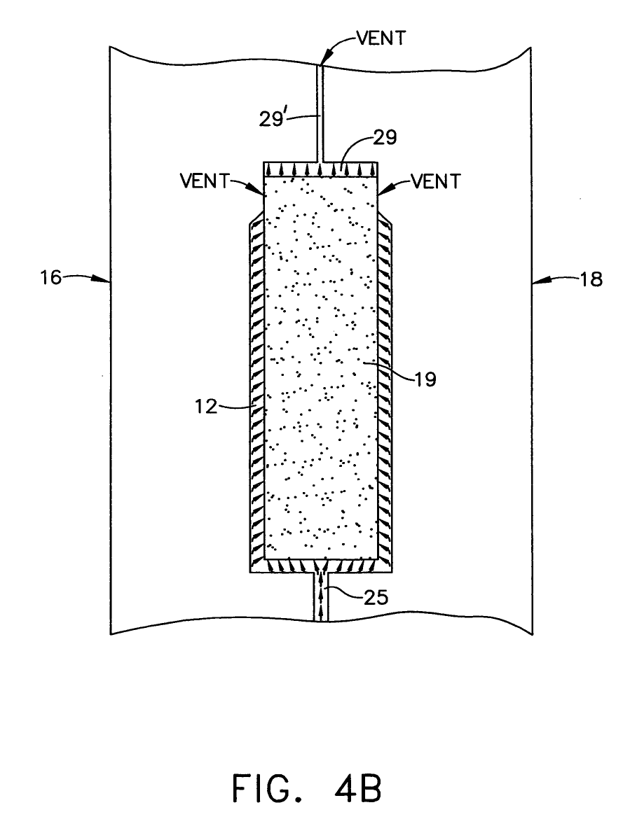

FIG. 4A is a cross-section along line A-A in FIG. 3A. FIG. 4A shows a side view of mating mold inserts 16 and 18 in accordance with this invention. FIG. 4A shows a nozzle 20 and runners 25 that cooperate to deliver molten resin or the like to a wheel key 19. A gap 12 borders each wheel beam key 19. FIG. 4A also shows vent channels 29′ through which gases can escape during RTM processing.

FIG. 4B shows an enlarged side view of an end portion mating mold inserts 16 and 18 in accordance with this invention. FIG. 4B shows a runner 25 that delivers molten resin to a wheel beam key 19. A gap 12 partially surrounds wheel beam key 19. FIG. 4B also shows vent area 29 and channel 29′ through which gases can escape during RTM processing.

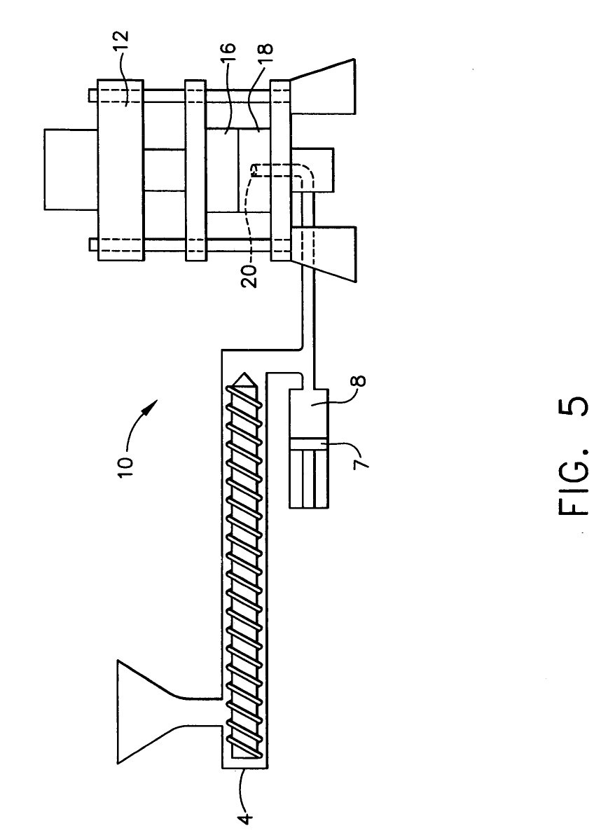

FIG. 5 is a schematic cross-section of an extrusion resin molding apparatus (10) according to an embodiment of the present invention. FIG. 5 shows an extruder (4) having a piston (7) and an accumulator (8); a mold (16, 18) arranged in the apparatus (10) so that resin can be extruded from the extruder (4) into the mold (16, 18); a nozzle (20) for delivering resin from the extruder (4) into the mold (16, 18); and a press (12) to force the mold (16, 18) closed during resin injection.

A typical specific resin would be an AR mesophase pitch resin (which is a catalytically polymerized naphthalene resin), although the invention is not restricted to this resin. For instance, the resin used in the present invention may be for instance an isotropic or mesophase coal tar or petroleum pitch. Other conventional resins well known to those skilled in the art can likewise be used in the present invention. Pitch tends to be highly viscous. One solution to high viscosity phenomena is to lower the viscosity by raising the temperature. However, increasing the temperature may adversely affect the properties of the resin and generate volatile gases within the pitch mass. As a result, raising the temperature of the resin can result in venting problems and the uneven densification of the preform. Accordingly, the ability to densify at higher viscosity and lower temperatures offer distinct advantages.

Anti-oxidants or oxidizers for stabilization can be added to the resin or pitch. Generally these would be in the liquid phase or in the form of nano-size particles in or to prevent plugging of the pores in the fibrous matrix.

The apparatus and method of embodiments of the present invention provide the ability to infiltrate a part with a high viscosity thermoplastic resin such as mesophase pitch. The preform can have from 5-70% porosity. A porosity of approximately 50% would in many cases be especially preferred. One embodiment of the present invention contemplates placing a porous preform into a mold, followed by evacuating the mold prior to injection. A vacuum can also be applied to the mold during injection. Alternately, no vacuum can be used. The preform can be preheated or heated within the mold. Molten pitch is then injected into the mold to densify the preform. The resin is allowed to cool inside the mold. The impregnated preform is then removed from the mold.

In more detail, fiber reinforced composite materials may be formed by impregnating or depositing a matrix within fibrous structures produced as described in this application. Thick fibrous structures used in fiber-reinforced composites are known as “preforms”. Various well known processes may be employed, alone or in combination, to deposit a matrix within the fibrous structure. Such processes include, for instance, resin impregnation, chemical vapor infiltration and deposition, and resin or pitch impregnation with subsequent pyrolyzation. Suitable processes and apparatuses for depositing a binding matrix within a porous structure are described, for instance, in U.S. Pat. No. 5,480,678, entitled “Apparatus for Use with CVI/CVD Processes”. The disclosure of U.S. Pat. No. 5,480,678 patent is incorporated by reference herein.

Specifically, for instance, after the fibrous skeleton is prepared, that carbon-fiber precursor matrix is infiltrated with molten pitch or with other carbon matrix precursors such as phenolic resin. The impregnated matrix is carbonized, for instance at 700-1500° C. for about 3 hours. This results in a carbon-carbon composite preform having a density of, for instance, approximately 1.25 grams per cubic centimeter. This preform may then be heat-treated to further open the porosity prior to additional densification. Alternatively, further densification may be carried out without heat treatment.

Whether the preform is heat-treated or not, for most applications the resulting preform is further densified. The densification processes that are used may be liquid phase resin densification followed by carbonization and/or densification may be accomplished by conventional CVI/CVD processes, as described above. Typically, combinations of these processes will be used until the carbon-carbon composite reaches a density in the range of 1.60 to 1.95 grams per cubic centimeter or even higher. At that time the composite may be heat-treated again to impart desirable physical properties to the composite material.

Those skilled in the art are acquainted with the basic techniques that may be used to implement this aspect of the present invention. Among the prior art disclosures that discuss such techniques, in addition to U.S. Pat. No. 5,480,678 mentioned above, are U.S. Pat. Nos. 5,587,203, 5,614,134, and 6,521,152 B1. The entire disclosure of each of U.S. Pat. No. 5,587,203, U.S. Pat. No. 5,614,134, and U.S. Pat. No. 6,521,152 B1 is incorporated by reference herein.

The mold can be treated with a release agent to facilitate removal of the densified preform. Typical release agents include long chain alkyl derivatives, natural products, synthetic polymers, fluorinated compounds and inorganic materials. Examples of release agents include, diethylene glycol monostearate, hydrogenated castor oil, stearic acid, oleic acid, zinc stearate, calcium stearate, ethylenebis (stearamide), oleyl palmitamide, microcrystalline wax, paraffin wax, carnauba wax, spemaceti wax, cellophane, cellulose acetate, sodium alginate, polydimethylsiloxane, polyalkylmethylsiloxane, polytetrafluoroethylene, polyfluoroacrylates, polyfluoroethers, polyethylene, polypropylene, polyvinyl alcohol, perfluorolauric acid, talc, kaolin, mica, silica, and graphite.

Full details on molding apparatuses and methods are disclosed in U.S. Pat. No. 6,537,470 B1, and the entire disclosure of that patent is expressly incorporated by reference herein.

### EXAMPLES

The following examples demonstrate the impregnation of preforms using the process and apparatus of the present invention.

### Example 1

A wheel beam key preform is prepared with braided partially oxidized polyacrylonitrile fibers. The initial length of the beam key preform is 16.5 inches, its width is 1.303 inches, and its thickness ranges from 1.607 to 1.796 inches, with the average thickness being 1.7015 inches. The initial density of the preform at this stage is 0.57 g/cc. After a first CVD procedure, the density is 1.26 g/cc. At this point the preform is machined, which reduces its length to 16.25 inches, its width to 2.75 inches, and its average thickness to 1.375 inches. The density of the machined preform is now 1.20 g/cc, having been reduced slightly by the loss of higher density material during the machining process. After a second CVD procedure, the density is raised to 1.64 g/cc. At this point the preform is again machined, which reduces its length to 14.75 inches, its width to 2.7 inches, and its average thickness to 1.33 inches. The density of the machined preform becomes 1.62 g/cc, being lowered slightly by the loss of higher density material during the machining process. The preform is now subjected to RTM, which raises its density to 1.78 g/cc. This data is summarized in the following Table:

| | Thickness, | | | |
|---|---|---|---|---|
| | average | Length | Width | Density |
| Stage | (inches) | (inches) | (inches) | (g/cc) |
| Pre 1^{st} CVD | 1.7015 | 16.5 | 3.03 | 0.57 |
| Post 1^{st} CVD | 1.7015 | 16.5 | 3.03 | 1.26 |
| Pre 2^{nd} CVD | 1.375 | 16.25 | 2.75 | 1.20 |
| Post 2^{nd} CVD | 1.375 | 16.25 | 2.75 | 1.64 |
| Pre 1st RTM | 1.33 | 14.475 | 2.7 | 1.62 |
| Post 1^{st} RTM | 1.33 | 14.475 | 2.7 | 1.78 |

### Example 2

The preform obtained in Example 1 is subjected to a 3^{rd} CVD process, which raises its density to 1.85 g/cc.

### Example 3

An injection molding apparatus including a hydraulic press with a 500 ton clamping ability is used. The standard shot size in the accumulator is 50 lb. (HDPE). The accumulator has a theoretical volume of 847 cubic inches (13,880 cm³), and the measured volume using resin is about 830 cubic inches (13,601 cm³). When completely filled with AR pitch resin, the accumulator contains approximately 37 lb. (16.8 kg) of resin. Pressure is supplied by the extruder screw, and the pressure is maintained in the accumulator. The pitch is extruded directly into the porous preform.

AR Pitch infiltration is performed on a nonwoven wheel beam key preform (200 hrs CVD, 1 cycle of CVD densification). The final weight of the preform is approximately 3 lbs. The final density of the wheel beam key preform impregnated with AR pitch is approximately 1.7 g/cc. The density of the preform after carbonization is approximately 1.66 g/cc.

Similarly, AR Pitch infiltration is performed on a fiber composite wheel beam key preform (300 hrs CVD, 1 cycle of CVD densification). The final weight of the preform is 2.5 lbs. The final density of the preform impregnated with AR pitch is 1.7 g/cc. The density of the preform after carbonization is 1.65 g/cc.

Again, AR Pitch infiltration is performed on a wheel beam key preform made with woven fabric segments (250 hrs CVD, 2 cycles of CVD densification). The final weight of the preform is 3.25 lbs. The final density of the preform impregnated with AR pitch is 1.7 g/cc. The density of the preform after carbonization is approximately 1.66 g/cc.

### Example 4

Multiple part impregnation with molten AR pitch resin is conducted. One preform is stacked on top of another, with high temperature gaskets separating the parts (top, bottom and center) to allow resin to flow around preforms for infiltration on all surfaces (see FIGS. 1 and 2). The preforms were separated by ⅛″ spacers used top and bottom (mold surface), and 1/16″ spacers used between stacked parts (preforms).

The extruder is run at 30 rpm. A shot of AR resin is collected in the accumulator. Several percentage points are added to the shot amount to give hold and pack conditions until gate freeze-off. Injection time for the 90% shot is 40 seconds. Maximum pressure is achieved briefly at the end of the shot (2750 psi). The parts are left in mold for 10 minutes to freeze the molten resin. The press is opened at 10 minutes. The preforms are removed and measured for weight gain and density.

### Example 5

A preform containing PAN-based carbon fiber and carbonized mesophase pitch is densified using CVD. The chopped fiber preform starting density is 1.25 g/cc. The dimensions of the preform are 3″″ in width, 2″ in average thickness, and 16″ in length with two shoulders at one end of 0.2″.

Prior to the injection, the resin is dried in a Conair loader/dryer, that has been modified to handle dusty friable material, for about 4 hours at 200° F. The extruder is run at 30 rpm. The shot injection times is 20-40 seconds. The maximum pressure at the end of the shot injection is 1800 psi. The starting density of the preform is 1.14 g/cc. The final density after infiltration is 1.7 g/cc. The beam key is then further densified by CVI to 1.75 g/cc.

### Example 6

A preform containing PAN-based carbon fiber and carbonized mesophase pitch is densified using CVI. The nonwoven fabric preform starting density is 1.2 g/cc. The dimensions of the preform are 2.5″ in width, 1.5″ in average thickness, and 15″ in length with two shoulders at one end of 0.1″.

The preform is densified by CVD to 1.6 g/cc to toughen it prior to pitch infiltration. The pitch is dried in a Conair loader/dryer that has been modified to handle dusty friable material for about 5 hours at 200° F. The extruder is run at 30 rpm. The shot injection time is 20-40 seconds. The maximum pressure at the end of the shot injection is 1800 psi. The starting density of the CVD-toughened preform is 1.6 g/cc. The final density after infiltration is 1.82 g/cc, and becomes 1.78 g/cc after subsequent carbonization. Further CVD processing raises the density to 1.85 g/cc.

What is claimed is:

1. A resin transfer molding apparatus which comprises:
an extruder;
at least two mold cavities contained within a mold in the apparatus, arranged so that resin can be extruded from the extruder into the mold;
a nozzle for delivering resin from the extruder into the mold;
runners in the body of the mold to deliver resin from the nozzle to a mold cavity within the mold;
a venting area contiguous to each said mold cavity to permit gases to escape from said mold cavity when said mold cavity is infiltrated with resin; and
a press to force the mold closed during at least resin injection, wherein said mold cavities are configured to accept parts that are characterized by variations in length, width, and/or thickness.

2. The resin transfer molding apparatus of claim 1, wherein the mold cavities are configured in the form of a wheel beam key preform having the dimensions 1″ to 5″″ in width, 1″ to 3″ in thickness, and 12″ to 20″ in length.

3. The resin transfer molding apparatus of claim 1, which further comprises a piston accumulator disposed between the extruder and the mold.

4. The resin transfer molding apparatus according to claim 1, wherein the mold comprises:
a top half;
a bottom half opposed to the top half, wherein the top half and the bottom half are configured to form at least two separate mold cavities in the shape of wheel beam keys;
at least one gate disposed in the top half or the bottom half or both;
a valve, wherein the valve can admit resin into the gate in the top half or the bottom half;
at least two separate runners to conduct resin from said gate separately to said at least two separate mold cavities; and
at least two arrangements to separately vent and/or vacuum said at least two separate mold cavities.

5. The resin transfer molding apparatus according to claim 4, wherein each of said at least two separate runners has shutoff means to enable utilization of the mold when less than all of said at least two separate mold cavities is to be utilized.

6. The resin transfer molding apparatus according to claim 4, wherein the gate comprises a nozzle disposed in the center of a face of either the top half or the bottom half.

7. The resin transfer molding apparatus according to claim 4, wherein the mold further comprises a vent ring fitted with at least one vent port or vacuum port, or both.

8. The resin transfer molding apparatus according to claim 7, wherein the mold further comprises an external vent port which is channeled to the vent ports fitted on the vent ring.

9. A resin transfer molding process which comprises the steps of:
placing a porous preform that is characterized by variations in length, width, and/or thickness into a mold held in a press;
injecting a molten resin or pitch into the mold, wherein an extruder is used for injecting the resin;
allowing the resin to cool below the melting point; and
removing the impregnated preform from the mold.

10. The resin transfer molding process according to claim 9, wherein said porous preform is a wheel beam key preform.

11. The resin transfer molding process according to claim 10, wherein the mold comprises:
a top half;
a bottom half opposed to the top half so that the top half and the bottom half form a mold cavity in the shape of a wheel beam key;
at least one gate and runner disposed in the top half or the bottom half or both;
a valve, wherein the valve can admit resin into the gate; and
an arrangement to provide venting and/or vacuum to the mold.

12. The resin transfer molding process according to claim 11, wherein the preform is a fibrous preform, a carbon fiber preform, a nonwoven preform, a random fiber preform with a binder, or a foam preform.

13. The resin transfer molding process according to claim 12, wherein the preform has been previously resin infiltrated and carbonized.

14. The resin transfer molding process according to claim 11, wherein the preform is heated to a temperature between about 290-425° C. prior to or after being placed in the mold and the mold is heated to a temperature between about 138-310° C.

15. The resin transfer molding process according to claim 11, wherein the resin or pitch is synthetic pitch, coal tar pitch, petroleum pitch, mesophase pitch, high char yield thermoset resin or combinations thereof.

16. The resin transfer molding process according to claim 11, in which multiple parts are loaded in a single mold.

17. The resin transfer molding process according to claim 11, which further comprises the steps of:
oxygen-stabilizing the impregnated preform by heating the impregnated preform in the presence of an oxygen containing gas a temperature of about 150-300° C.; and
carbonizing the oxygen-stabilized impregnated preform at a temperature above about 650° C.; and graphitizing the carbonized impregnated preform at a temperature of about 1400-2500° C.

18. The resin transfer molding process according to claim 17, which comprises further densifying the graphitized preform using chemical vapor infiltration (CVI), chemical vapor deposition (CVD), and/or resin transfer molding (RTM).

19. The resin transfer molding process according to claim 11, wherein a vacuum is provided to the mold prior to injecting the molten resin.

20. The resin transfer molding process according to claim 11, wherein a vacuum and/or venting is provided to the mold during the resin injection.
